(19) United States
(12) Patent Application Publication
(10) Pub. No.: US 2017/0025921 A1
(43) Pub. Date: Jan. 26, 2017

(54) DRIVE MECHANISM FOR TRANSFERRING ROTATIONAL MOTION FROM AN ELECTRIC MOTOR TO AN APPLIANCE

(71) Applicant: DRIVEN INNOVATIONS LLC, Englewood, OH (US)

(72) Inventors: Eric J. Kirker, Dayton, OH (US); William R. Patterson, Miamisburg, OH (US); William Royer, Louisville, OH (US); Tag McGough, Clayton, OH (US)

(21) Appl. No.: 14/805,866

(22) Filed: Jul. 22, 2015

(51) Int. Cl. H02K 7/00; H02K 5/00; F16D 1/10; F16D 1/064; H02K 7/14; F16D 1/06

(52) U.S. Cl. CPC H02K 7/003; H02K 7/14; F16D 1/06; F16D 1/10; F16D 1/064; H02K 5/00; F16D 2001/103

(57) ABSTRACT

An assembly for transmitting power to an appliance, is disclosed. The appliance is placed upon a counter top that defines an aperture. The assembly includes an electric motor, a rotatable shaft driven by the electric motor, and a drive mechanism removably coupled to the rotatable shaft. The electric motor and the rotatable shaft are located below a first side of the counter top and are hidden from view. The drive mechanism is removably coupled to the rotatable shaft. The drive mechanism includes a first portion removably coupled to the rotatable shaft and a second portion that defines a drive socket shaped to receive a male portion of the appliance. At least a portion of the drive mechanism extends through the aperture in the counter top and is located above a second side of the counter top.

### FIELD

The disclosure relates generally to a space-saving drive mechanism and, more particularly, to an electric motor, a shaft driven by the electric motor, and a drive mechanism that translates rotational movement of the shaft to an appliance, where the electric motor and the shaft are hidden from view by a counter top.

### BACKGROUND

Kitchen appliances may utilize electric motors to blend or otherwise process food or other items for consumption. Kitchen appliances usually employ an electric motor to provide the power required for operation. Some types of kitchen appliances utilizing an electric motor for processing food items include, but are not limited to, blenders, food processors, ice cream makers, meat grinders, mixers, drink makers, and coffee grinders. Kitchens may be found not only in the home, but also within vehicles such as, for example, recreational vehicles, boats, airplanes, food trucks, and yachts. However, it is to be appreciated that these types of vehicles are typically limited in size, and therefore do not have the same capacity to accommodate as many amenities as the home. Thus, many vehicles may incorporate various types of space-saving features in an effort to allow for the vehicle to be compact, without sacrificing desired amenities. For example, a vehicle may include a variety of retractable or foldable furniture items to save space.

The kitchen of the vehicle may also include space-saving features as well. In particular, it may be especially desirable for a kitchen countertop of a vehicle to incorporate space-saving features, since the kitchen countertop is typically limited in size. Moreover, a user may have various appliances such as a blender, a mixer, and a coffee grinder that he or she may want to use within the vehicle. However, it may be difficult for the user to accommodate all of the appliances on the kitchen countertop. Thus, there is a continuing need in the art for space-saving kitchen technologies that enable a user to fit multiple appliances within a vehicle.

### SUMMARY

In one embodiment, an assembly for transmitting power to an appliance, is disclosed. The appliance is placed upon a counter top that defines an aperture. The assembly includes an electric motor, a rotatable shaft driven by the electric motor, and a drive mechanism removably coupled to the rotatable shaft. The electric motor and the rotatable shaft are located below a first side of the counter top and are hidden from view. The drive mechanism is removably coupled to the rotatable shaft. The drive mechanism includes a first portion removably coupled to the rotatable shaft and a second portion that defines a drive socket shaped to receive a male portion of the appliance. At least a portion of the drive mechanism extends through the aperture in the counter top and is located above a second side of the counter top.

In another embodiment, an assembly for transmitting power to an appliance is disclosed. The appliance is placed upon a counter top that defines an aperture and an upper surface. The assembly includes an electric motor, a rotatable shaft driven by the electric motor, a drive mechanism permanently coupled to the rotatable shaft. The electric motor and the rotatable shaft are located below a first side of the counter top and are hidden from view. The drive mechanism defines an uppermost surface, a first portion permanently coupled to the rotating shaft, and a second portion that defines at least one retaining feature shaped to removably couple a driver for the appliance. The uppermost surface of the drive mechanism is substantially flush with the upper surface of the counter top and is visible through the aperture defined by the counter top.

In yet another embodiment, an assembly including an electric motor, a rotatable shaft driven by the electric motor to create rotational motion, an appliance having a male piece that transfers the rotational motion of the rotatable shaft to a working piece, and a drive mechanism is disclosed. The electric motor and the rotatable shaft are located below a first side of the counter top and are hidden from view. The drive mechanism is removably coupled to the rotatable shaft. The drive mechanism includes a first portion removably coupled to the rotatable shaft and a second portion that defines a drive socket shaped to receive the male piece of the appliance. At least a portion of the drive mechanism extends through the aperture in the counter top and is located above a second side of the counter top.

Other objects and advantages of the disclosed method and system will be apparent from the following description, the accompanying drawings and the appended claims.

### BRIEF DESCRIPTION OF THE DRAWINGS

FIG. 1 is a front view of an electric motor and an embodiment of the disclosed drive mechanism;

FIG. 2 is a cross-sectioned view of the electric motor and the drive mechanism of FIG. 1, taken along section line A-A;

FIG. 3 is a bottom view of the drive mechanism shown in FIGS. 1-2;

FIG. 4 is a top view of the electric motor and the drive mechanism of FIG. 1, taken along section line D-D in FIG. 2;

FIG. 5 is an elevated perspective view of a counter, where the drive mechanism shown in FIGS. 1 and 2 has been removed and a cap is placed therein to create a flush working surface;

FIG. 6 is an elevated view of the counter shown in FIG. 5 including the drive mechanism, where a pad and a pad adapter are placed upon the counter to provide a mounting system for an appliance;

FIG. 7 is a cross-sectioned view of the cap and the counter shown in FIG. 5, where the cap is installed within a fitting;

FIG. 8 is a top view of the cap;

FIG. 9A is a cross-sectioned view of a fitting and a motor mount shown in FIG. 2;

FIG. 9B is an enlarged, cross-sectioned view of a portion of the motor mount engaged with a grommet of an upper motor casting of the electric motor;

FIG. 10 is an elevated view of an exemplary blender that is driven by the drive mechanism shown in FIG. 2, where the blender includes controls on a lid;

FIG. 11 is an illustration of the blender where the controls are located on both the lid and a handle of the blender;

FIG. 12 is an illustration of the blender where the controls are located on the handle of the blender;

FIG. 13 is a bottom perspective view of the blender, where a position sensor is located along a lower surface of an adapter of the blender;

FIG. 14 is an exemplary schematic diagram of the lid illustrated in FIG. 10, the control module, and the electric motor;

FIG. 15 is a front view of the electric motor and an alternative embodiment of the drive mechanism;

FIG. 16 is a cross-sectioned view of the electric motor and the drive mechanism of FIG. 15, taken along section line B-B;

FIG. 17 is a top view of the drive mechanism shown in FIG. 15;

FIG. 18 is an enlarged view of a drive socket, a pad, and an adapter shown in FIG. 16;

FIG. 19 is a front view of the drive mechanism, the electric motor and the motor mount shown in FIG. 16, where the housing and the counter top have been omitted; and

FIG. 20 is a perspective view of the drive mechanism, the electric motor and the motor mount in FIG. 19.

### DETAILED DESCRIPTION

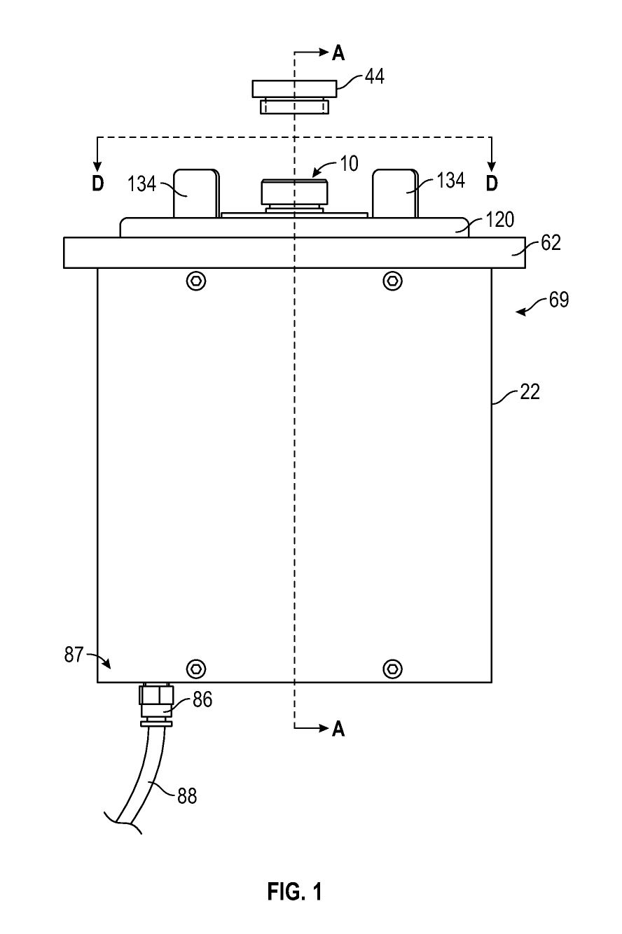

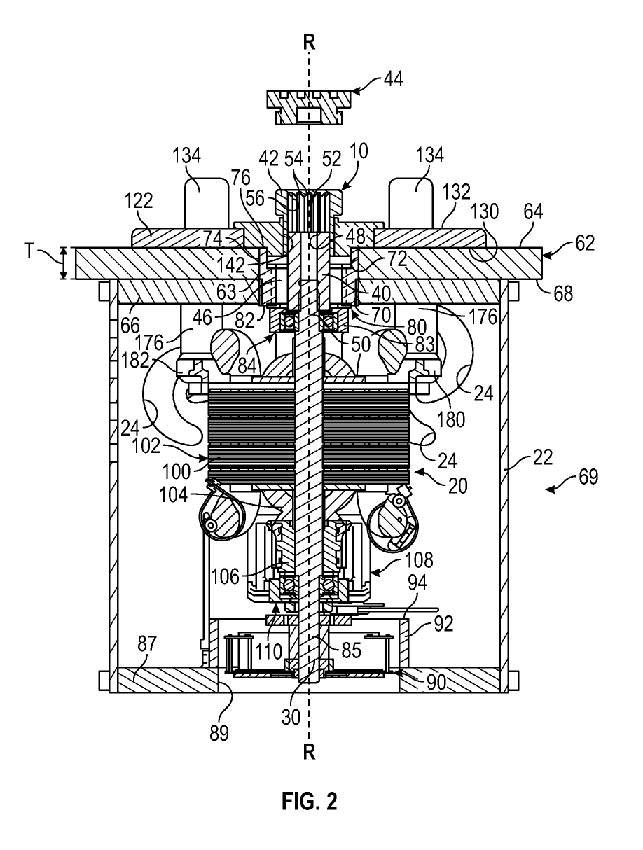

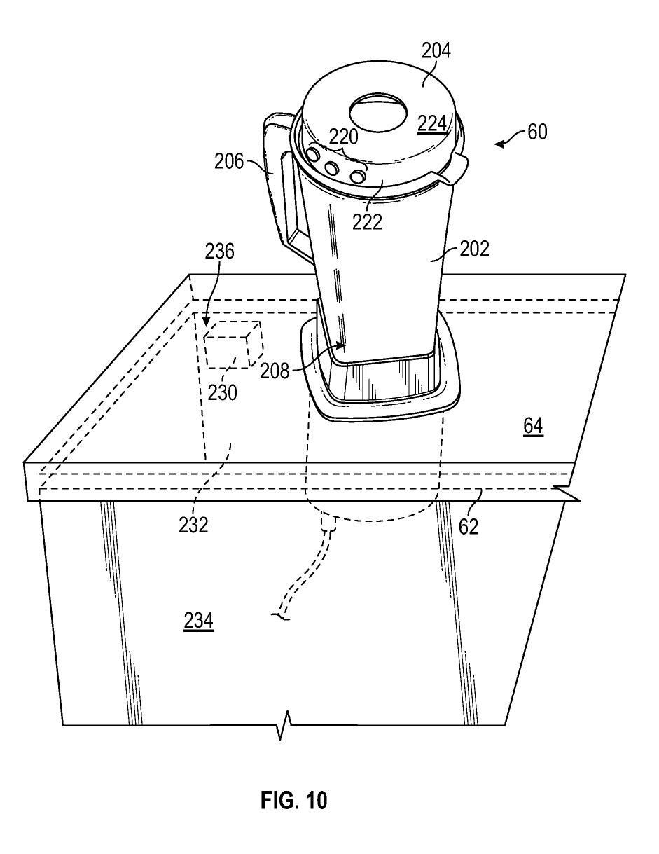

As shown in FIGS. 1 and 2, the disclosed drive mechanism 10 may be coupled to an electric motor 20 (visible in FIG. 2). The electric motor 20 may be any type of electric motor. In one exemplary embodiment, the electric motor 20 is a universal motor that operates on single phase AC or DC power, or a brushless motor. A housing 22 may contain the electric motor 20. As seen in FIG. 2, the housing 22 may define one or more cooling apertures 24 that allow for air to be pulled through the housing 22, thereby providing cooling to the electric motor 20. In the embodiment as shown in FIG. 2, the cooling apertures 24 are shaped as generally as a pair of crescents that interlock with one another, and are representative of a company logo. However it is to be understood that the cooling apertures 24 may include any type of profile or shape. For example, in one embodiment, the apertures 24 may be shaped as another company's logo. The electric motor 20 may be used to drive a rotatable shaft 30. As explained in greater detail below, the drive mechanism 10 is removably coupled to the shaft 30 and transmits rotational motion from the shaft 30 of the electric motor 20 to an appliance (shown in FIGS. 10-13).

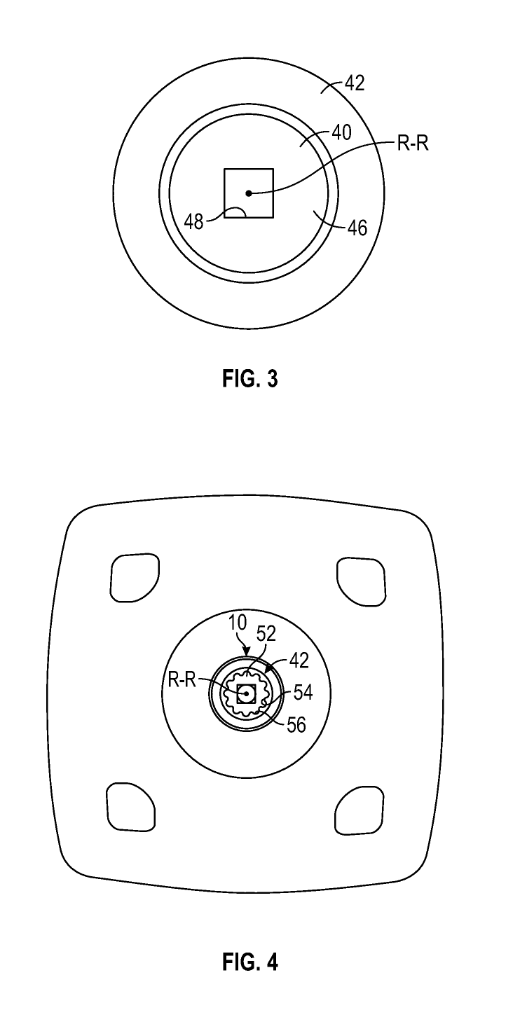

The drive mechanism 10 may include two parts, a shaft 40 and a coupling 42. The shaft 40 may be joined or attached to the coupling 42. For example, in one embodiment, the shaft 40 and coupling 42 may be constructed of a mild steel or a stainless steel, and are then welded or silver soldered together. In another embodiment, the shaft 40 and coupling 42 may be constructed of aluminium and welded together, and then hard anodized. Referring to FIGS. 2 and 3, the shaft 40 may define a centrally located cavity 48 located along an axis of rotation R-R of the shaft 30. The cavity 48 of the shaft 40 is shaped to removably retain an upper portion 50 of the shaft 30. For example, as seen in FIG. 3, the cavity 48 of the connecting shaft 40 may be generally square shaped. The shaft 30 may include a corresponding profile (not illustrated in the figures) that is received by the cavity 48 of the shaft 40, thereby coupling the shaft 30 to the drive mechanism 10. Thus, the shaft 30 and the drive mechanism 10 may rotate together with another.

FIG. 4 is a top view of the drive mechanism 10, taken at section line D-D shown in FIG. 1. Referring to both FIGS. 2 and 4, the coupling 42 may define a female portion or drive socket 52. A plurality of splines 54 may be arranged around an inner surface 56 of the drive socket 52 of the coupling 42. In the embodiment as shown in the figures, the splines 54 are substantially parallel with the axis of rotation R-R of the shaft 30. The drive socket 52 of the coupling 42 of the drive mechanism 10 is shaped to receive a male piece (not illustrated) of an appliance. The drive socket 52 of the coupling 42 transfers the rotational motion of the shaft 30 to the male piece of the appliance. The male piece may be part of an appliance that transfers the rotational motion of the shaft 30 of the electric motor 20 to a working piece. For example, in the embodiment as shown in FIG. 10-13, the appliance is a blender 60, and the working piece is a blade (not illustrated) used to blend food or beverage items. Accordingly, the male piece would transfer the rotational motion of the shaft 30 to the blade.

While a blender 60 is illustrated in the figures and is described in detail below, it is to be appreciated that the disclosure is not limited to a blender. Indeed, the drive mechanism 10 may be used to transfer rotational motion of the shaft 30 to any number of appliances such as, but not limited to, a food processor, a vacuum cleaner, an air compressor, an ice cream maker, a meat grinder, a bread maker, a mixer, a drink maker, or a coffee grinder.

In one approach, the drive socket 52 of the coupling 42 of the drive mechanism 10 may be shaped to receive a male piece (not illustrated) unique to a specific appliance. Thus, it is to be appreciated that the drive mechanism 10 as shown in FIGS. 1-4 is removable from the shaft 30, and may be replaced with another drive mechanism that corresponds to another appliance. For example, the drive socket 52 of the drive mechanism 10 as shown in FIGS. 1-4 may correspond to the male portion of the blender 60 (FIGS. 10-13). However, if a user wishes to operate a mixer instead of the blender 60, the user may remove and replace the drive mechanism 10 with another drive mechanism having a drive socket shaped to receive the male portion of the mixer. Thus, it should be appreciated that the drive mechanism 10 may be adaptable to accommodate any number and variety of appliances. Specifically, the drive mechanism 10 may be adaptable to accommodate, for example, any commercially available jar, or even a proprietary jar of a blender. It also appreciated that the drive mechanism 10 may be removed by the user without the need for any specialized tools. It should also be understood that that while the drive mechanism 10 as shown in FIGS. 1-4 is removable, in another alternative embodiment which is discussed below and illustrated in FIGS. 15-18, the drive mechanism is a permanent fixture.

If the drive mechanism 10 is not currently being used, the drive mechanism 10 may be removed and a removable cover or cap 44 may be used to seal off a void or cavity 46 (seen in FIG. 2) created by the removal of the drive mechanism 10. The cap 44 is described in greater detail below, and may be used to substantially prevent the ingression of fluids into the housing 22 when the drive mechanism 10 is not being used. The cap 44 may further be used to enhance or improve the overall appearance of a working surface or counter top 62 (shown in FIG. 2) when the drive mechanism 10 is not being used, and is also explained in greater detail below.

Referring to FIG. 2, the electric motor 20, the housing 22, and the shaft 30 may all be located behind a first side (i.e., below) the counter top 62. Thus, the electric motor 20 acts as an invisible drive mechanism, where the shaft 30 of the electric motor 20 provides rotational motion to an appliance, but the electric motor 20, the housing 22, and the shaft 30 are each hidden by the counter top 62, and therefore are not visible to a user (i.e., the electric motor 20 and the shaft 30 are a ghost or invisible drive). However, as explained below, the coupling 42 of the drive mechanism 10 is visible to a user. In one exemplary embodiment, the counter top 32 may be a kitchen counter top. The kitchen may be located in a recreational vehicle, a boat, airplane, van, food truck, any other vehicle, or even an outdoor kitchen found on a patio or deck. Alternatively, the counter top 62 may be part of any other permanent or semi-permanent structure as well such as, but not limited to, a gas grill shelf, a cooler, outdoor furniture, or a shelf assembly. It is to be appreciated that these examples are merely exemplary in nature, and the counter top 62 may be found in any structure that serves as a working surface where food, beverage, or other items are prepared.

The counter top 62 may define an upper surface 64 where a user may prepare items such as, but not limited to, food and beverages. A user may also utilize the counter top 62 for operating various appliances, such as the blender 60 illustrated in FIGS. 10-13. A motor mount 66 of the electric motor 20 may be affixed along a bottom surface 68 of the counter top 62. In one exemplary approach, the motor mount 66 may be affixed to the bottom surface 68 of the counter top 62 by an adhesive. It is to be appreciated that the drive mechanism 10, electric motor 20, the housing 22, and the motor mount 66 define a modular assembly 69 that may be easily and quickly installed by a user. Furthermore, it should also be appreciated that the modular assembly 69 may be installed in any location along the bottom surface 68 of the counter top 62, thus providing flexibility in mounting locations. Accordingly, the drive mechanism 10 and the electric motor 20 may be installed in a variety of locations, and may even be installed in a location where space is relatively limited and includes various packaging constraints.

A fitting 63 may surround the upper portion 50 of the shaft 30 of the electric motor 20 as well as a portion of the drive mechanism 10. The fitting 63 may be threadingly engaged with an aperture 70 defined by the motor mounting 66, as well as an aperture 72 defined by the counter top 62. Specifically, an exterior surface 74 of the fitting 63 may include threads. The threads located along the exterior surface 74 of the fitting 63 may engage with threads located around the aperture 70 of the motor mounting 66 as well as threads located around the aperture 72 of the counter top 62 (the threading is shown as a dotted line in FIG. 2).

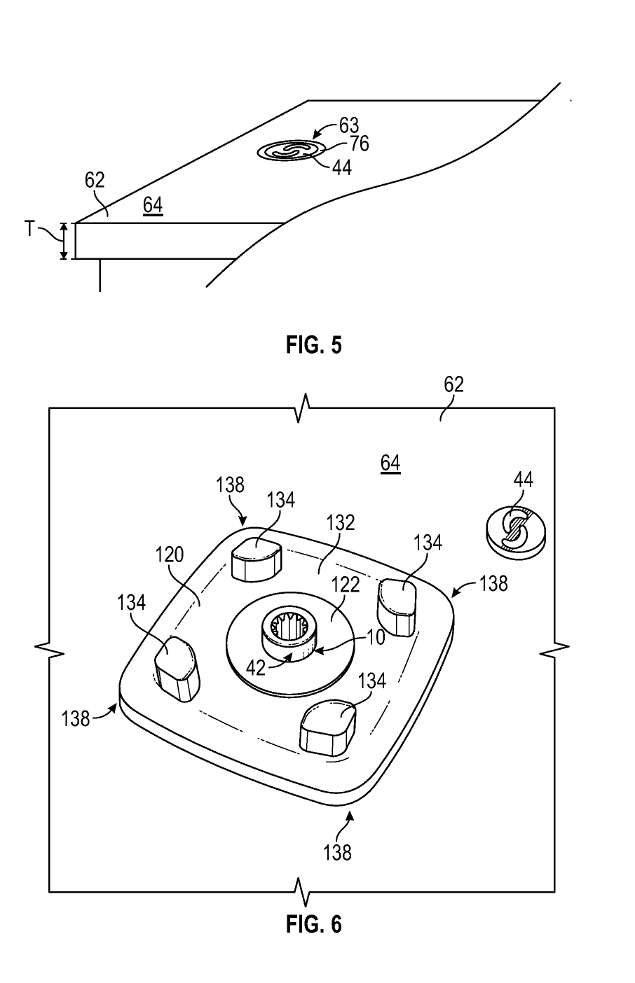

Referring to FIGS. 2 and 5, the fitting 63 may include an upper surface 76 that is substantially flush with the upper surface 64 of the counter top 62. It is to be appreciated that the fitting 63 is adjustable such that the upper surface 76 may always be flush with the upper surface 64 of the counter top 62. Specifically, during installation a user may threadingly engage and rotate the fitting 63 with the aperture 70 of the motor mounting 66 and the aperture 72 of the counter top 62. The user may continue to rotate the fitting 63 within the counter top 62 until the upper surface 76 of the fitting 63 is flush with the upper surface 64 of the counter top 62. Thus, the fitting 63 may always be flush with the upper surface 64 of the counter top 62, regardless of the thickness T of the counter top 62.

The fitting 63 may provide a fluid-tight seal between the electric motor 20 and the upper surface 64 of the counter top 62 and the motor mount 66. A seal 80 may be located along a bottom surface 82 of the fitting 42 and a bearing casting 83 of an upper bearing 84 of the electric motor 20. The seal 80 may also substantially prevent fluids from entering the electric motor 20. However, in the event fluid enters the housing 22, a fitting 86 (FIG. 1) may be affixed along a bottom plate 87 of the housing 22. Referring to FIGS. 1 and 2, the fitting 86 may be connected to a drain hose 88 to transport fluid out of the housing 22. Furthermore, in the event the drain hose 88 becomes plugged or is otherwise non-functional, fluid may drain out of the housing 22 through a centrally located aperture 89 located along the bottom plate 87 of the housing 22. Specifically, a motor fan 90 may be mounted around a bottom portion 85 the shaft 30. The motor fan 90 may draw cooling air over the electric motor 20. However, it is to be appreciated that in another embodiment, a water-cooled motor may be used instead, since the motor is hidden from view by and is permanently mounted to the counter top 62.

The centrally located aperture 89 of the housing 22 may be located directly below the motor fan 90, and a shelf 92 may surround the centrally located aperture 89. In the event fluid accumulates along the bottom plate 87 of the housing 22, the centrally located aperture 89 may allow for the fluid to exit the housing. Specifically, fluid may only accumulate along the bottom plate 87 of the housing 22 until the fluid reaches a top portion 94 of the shelf 92. The fluid may then flow over the top portion 94 of the shelf 92, and then exits the housing 22 through the centrally located aperture 89 within the bottom plate 87. Thus, it is to be appreciated that fluids may only reach an elevation as far as the top portion 94 of the shelf 92 within the housing 22. Once the fluid reaches the top portion 94 of the shelf 92, the fluid may then exit the housing 22 through the centrally located aperture 89. Accordingly, fluid may not make contact with the electrical motor 20 itself. Specifically, fluid may not make contact with the various components of the electric motor 20 such as, for example, windings 100 of a stator 102, a rotor 104, a commutator 106, brushes 108, or a lower bearing 110.

In another embodiment, a water slinger (not illustrated in the figures) may be added to the electric motor 20, which in turn makes the electric motor 20 fluid or water resistant. In one example, the water slinger may be a slinger type seal placed around the shaft 30, and substantially prevents fluids from entering the electric motor 20. It is to be appreciated that a catch basin (not illustrated) may also added to the water slinger, which allows for any accumulated fluid from travelling to a located underneath the counter top 62 (i.e., water may not flood the cabinet enclosure below the counter top 62).

FIG. 6 is an elevated perspective view of a pad 120, a pad adapter 122, and the coupling 42 of the drive mechanism 10. As seen in FIG. 6, the cap 44 has been removed from the drive mechanism 10 by a user, and is placed along the upper surface 64 of the counter top 62. Referring to FIGS. 2 and 6, a lower surface 130 of the pad 120 may be placed along the upper surface 64 of the counter top 62. The pad 120 may define an upper surface 132 that includes one or more projections 134. As seen in FIG. 6, four projections 134 may be arranged along the upper surface 132 of the pad 120 in corresponding corners 138. The projections 134 may be used to position an appliance, such as the blender 60 shown in FIG. 10-13 along the counter top 62.

Although four projections 134 are illustrated in FIG. 6, it should be appreciated that the upper surface 132 of the pad 120 may include a variety of positioning features to accommodate an appliance. For example, in the embodiment as shown in FIGS. 10-13, the blender 60 includes a blender jar 202. A bottom portion 208 of the jar 202 may be shaped to flare or extend over the four projections 134. Furthermore, although the figures illustrate the pad 120 being placed along the upper surface 64 of the counter top 62, in another embodiment a recess shaped to accommodate the pad 120 may be defined along the upper surface 64 of the counter top 62. Thus, the upper surface 132 of the pad 120 is flush with the upper surface 64 of the counter top 62.

The pad 120 may be constructed of a flexible material such as, for example, urethane, 30 to 60 durometer rubber, or another moldable soft compound that provides a non-skid, level surface for a user to place an appliance upon. Specifically, the pad 120 may provide a levelling surface that is substantially parallel with the upper surface 64 of the counter top 62. The pad 120 may define a centrally located aperture 140 (shown in FIG. 2), which is shaped to receive the pad adapter 122. The pad adapter 122 may be used to position or center the pad 120 around the drive mechanism 10. The pad adapter 122 may define a centrally located aperture 142 that is shaped to receive the coupling 42 of the drive mechanism 10. The pad adapter 122 may be constructed of a non-conductive material such as, for example, plastic. Although the figures illustrate a pad adapter 122, it is to be appreciated that in one embodiment the pad adapter 122 may be omitted, and instead the aperture 140 of the pad 120 may be shaped to receive the coupling 42 of the drive mechanism 10 instead.

The pad 120 and the pad adapter 122 may both be placed along the upper surface 64 of the counter top 62 to provide a mounting system for an appliance such as the blender 60 seen in FIGS. 10-13. The pad 120 and the pad adapter 122 may be used to substantially prevent the ingression of fluids into the housing 22 when the drive mechanism 10 is being used to transmit rotational motion from the shaft 30 of the electric motor 20 to an appliance. However, it is to be appreciated that the pad 120 and the pad adapter 122 may be easily removed by a user once the appliance is no longer being used. Specifically, both the pad 120 and the pad adapter 122 may be removed from the counter top 62.

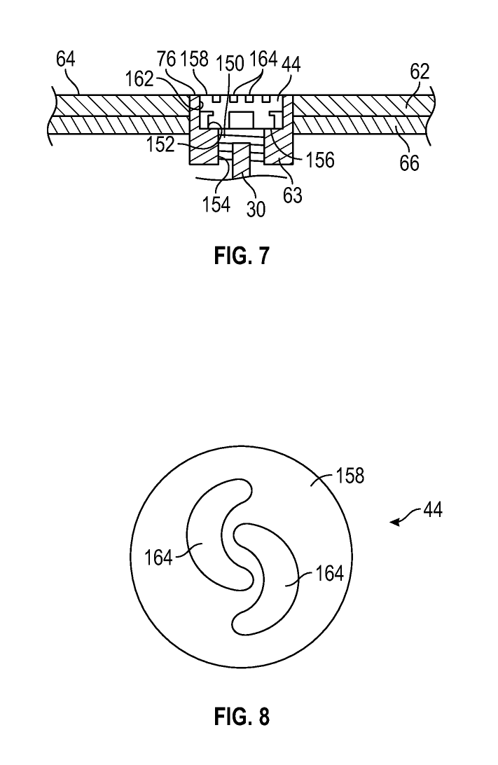

Referring to FIGS. 1-2 and 5-6, once a user is finished using the appliance, the user may then remove the drive mechanism 10 from the upper portion 50 of the shaft 30. The user may also remove the pad 120 and the pad adapter 122 from the upper surface 64 of the counter top 62. The user may then insert the cap 44 into the cavity 46 (seen in FIG. 2) created by the removal of the drive mechanism 10 from the shaft 30. Specifically, as seen in FIG. 7, the fitting 63 may define a stepped recess 150 shaped to receive the cap 44. In particular, a step 152 may be defined along a threaded inner wall 154 of the fitting 63. When the cap 44 is placed within the stepped recess 160 of the fitting 63, a lower surface 156 of the cap 44 may rest against the step 152 located along the inner wall 154 of the fitting 63.

Referring to FIGS. 5 and 7, the cap 44 may also define an upper surface 158. The upper surface 158 of the cap 44 is flush with the upper surface 76 of the fitting 63. The upper surface 158 of the cap 44 also seals off an opening 162 defined by the upper surface 76 of the fitting 63 (seen in FIG. 7) such that the cap 44 substantially prevents ingression of fluid into the stepped recess 150 of the fitting 63. Thus, the cap 44 may act as a seal that allows for the entire counter top 62 to be a working surface, without the need for a user to carefully ensure that no fluid make contact with or comes close to the opening 162 of the fitting 63. As explained above, the upper surface 76 of the fitting 63 is flush with the upper surface 64 of the counter top 62. Thus, when the cap 44 is placed within the stepped recess 150 of the fitting 63, a smooth, continuous surface may be created along the upper surface 64 of the counter top 62. Accordingly, a user may be able to utilize the entire counter top 62 as a workspace. For example, if the counter top 62 is a kitchen counter, then the user may utilize the entire upper surface 64 for food preparation. Moreover, users may also find it aesthetically pleasing to have the upper surface 76 of the fitting 63 as well as the upper surface 158 of the cap 44 be flush with the counter top 62.

FIG. 8 illustrates the upper surface 158 of the cap 44. As seen in FIGS. 7-8, the upper surface 158 of the cap 44 may define one or more indentations or recesses 164. The recesses 164 provide a surface for a user to grasp to remove the cap 44 from the stepped recess 150 of the fitting 63. Similar to the apertures 24 of the housing shown in FIG. 1, the recesses 164 may include any shape, and in one embodiment the recesses 164 may be shaped as a company logo. Specifically, as seen in FIG. 8, the recesses 164 are a pair of crescents that interlock with one another and represent a company logo.

Referring to FIGS. 2 and 6-7, it is to be appreciated that the electric motor 20, the housing 22, and the shaft 30 are all located underneath the counter top 62 and are hidden from view, but at least a portion of the disclosed drive mechanism 10 is visible to a user. Specifically, the coupling 42 of the drive mechanism 10 extends through the centrally located aperture 142 defined by the pad adapter 122, and is thereby visible to a user. The shaft 40 of the drive mechanism 10 extends through the aperture 70 defined by the motor mounting 66, the aperture 72 defined by the counter top 62, and partially through the centrally located aperture 142 defined by the pad adapter 122. In other words, the electric motor 20, the housing 22, and the shaft 30 may all be located behind a first side (i.e., below) the counter top 62, but the drive mechanism 10 extends through not only the aperture 72 defined by the counter top 62 but also the aperture 142 defined by the pad adapter 122, and is located on a second side (i.e., above) the counter top 62, and there therefore visible to users.

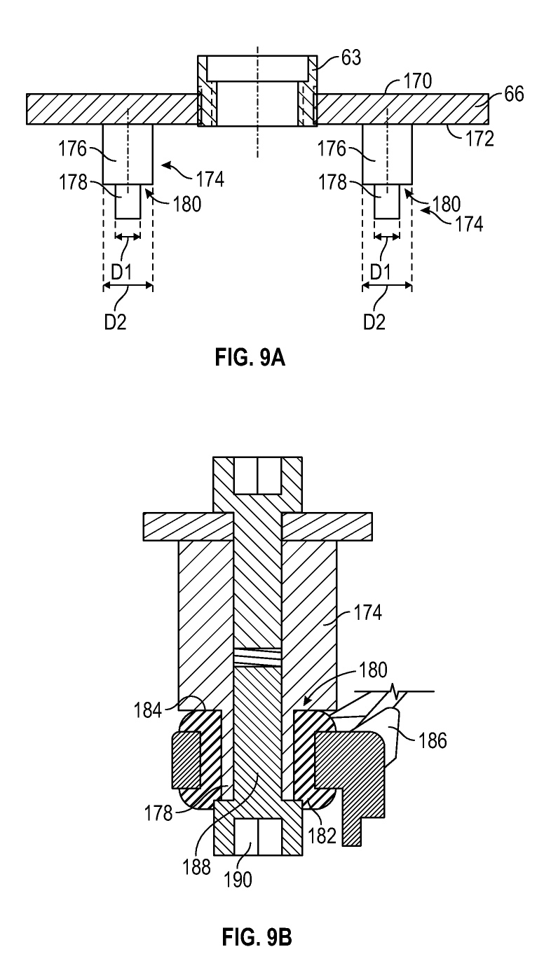

FIG. 9A is an illustration of the fitting 63 and the motor mount 66, where the counter top 62 and the drive mechanism 10 are omitted for purposes of clarity and simplicity. As seen in FIG. 9A, the motor mount 66 may define an upper surface 170 and a lower surface 172. The lower surface 172 of the motor mount 66 defines a plurality of mounts 174. Specifically, in the illustrated example the motor mount 66 includes four motor mounts 174, however only two of the mounts 174 are visible. The mounts 174 may include a first portion 176 and a second portion 178, where the first portion 176 defines a first diameter D1 that is greater than a diameter D2 defined by the second portion 178. A step 180 is defined between the first portion 176 and the second portion 178.

Referring to FIGS. 2 and 9A-9B, the second portion 178 of the mounts 174 may be received within corresponding grommets 182. Specifically, the steps 180 of the mounts 174 may each abut against a corresponding upper surface 184 of a corresponding one of the grommets 182. The grommets 182 may be constructed of rubber, and are located within an upper motor casting 186. It should be appreciated that a length of the second portion 178 of each of the mounts 174 may be shorter than an uncompressed height of the grommets 182. Thus, when the electric motor 20 is mounted upon the motor mount 66, and motor mounting screws 188 are subsequently tightened, the grommets 182 may each compress slightly against a head 190 of the screw 188 such that the height of the grommets 182 are now about the same as the height of the second portion 178 of each of the mounts 174. Such an arrangement acts as a vibration absorbing member, and may also provide sound dampening as well. It is to be appreciated that sound dampening features may not usually be applied to counter top portable appliances such as, for example, a portable counter top blender, as applying a sound dampening material may affect the overall aesthetic appearance of the portable appliance. Thus, the disclosed electric motor 20 and motor mount 66 may generate significantly less noise when compared to counter top portable appliances currently available.

FIGS. 10-13 illustrate various embodiments of the blender 60. FIG. 10 is one exemplary embodiment of the blender 60 located upon the counter top 62. The blender 60 includes the jar 202 and a lid 204 for sealing the jar 202. The jar 202 may define a handle 206 that provides a surface for a user to grasp and hold the jar 202.

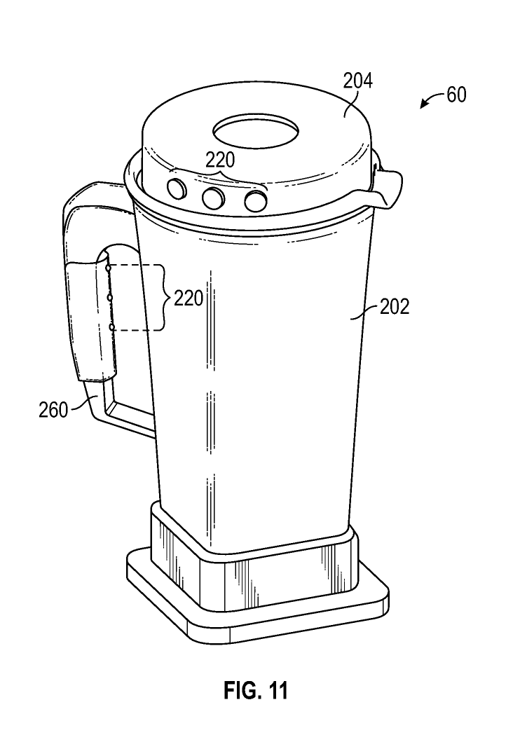

Continuing to refer to FIG. 10, the blender 60 may include various controls 220 for operation of the blender 60. In the embodiment as shown in FIG. 10, the controls 220 are located along a side surface 222 of the lid 204. However, this illustration is merely exemplary in nature, and the controls 220 may also be located along a top surface 224 of the lid 204 as well. Furthermore, as shown in FIGS. 11-13, the some or all of the controls 220 may also be located on the handle 206 of the jar 202.

Although the controls 220 are illustrated on the handle of the jar 202, this illustration is not intended to be limiting. It should be appreciated that the controls 220 may be located along another surface of the jar 202 as well. In another embodiment, the controls 220 may be mounted in a location remote from the blender 60 and the electric motor 20. For example, the controls 220 may be mounted on a wall, along a side of the counter top 62, or any other location within the kitchen. Furthermore, it should also be appreciated that that controls 220 may be part of a control panel (not illustrated) that may be mounted on a surface remote from the electric motor 20 (e.g., the upper surface 64 of the counter top 62 or a wall). However, it is to be appreciated that if the controls 220 may be mounted upon either the jar 202 or the lid 204 instead of the upper surface 64 of the counter top 62, this allows for the entire counter top 62 to be free of electronic controls. This in turn results in an increased amount of work space on the counter top 62, which may be especially beneficial in an application where space is limited. Some examples of these types of applications include, for example, a kitchen in a yacht, a recreational vehicle, or an airplane. Thus, locating the controls 220 along either jar 202 or the lid 204 may be a space-saving feature that effectively increases the total working area of the counter top 62.

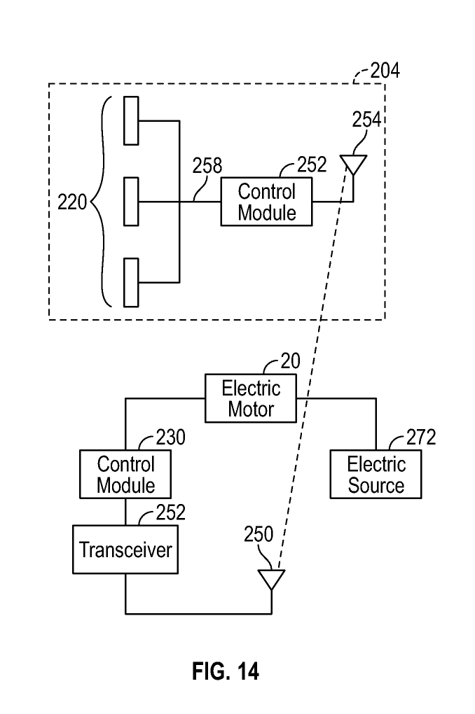

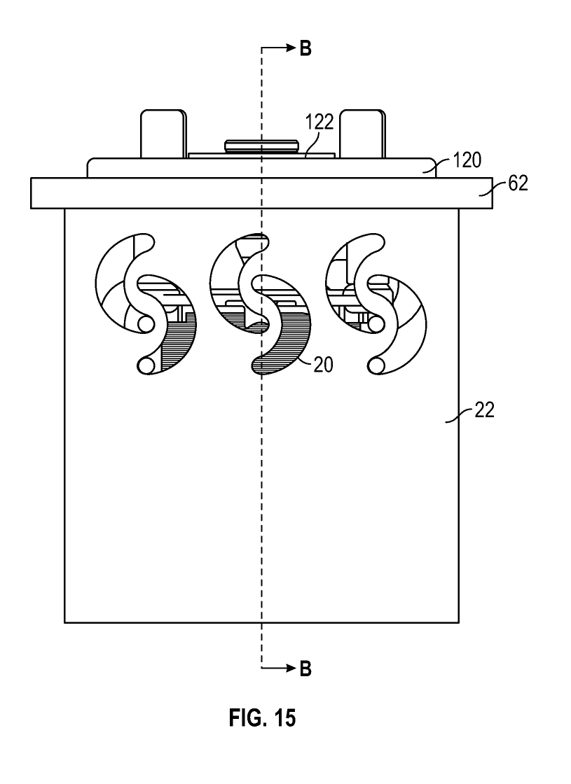

It is to be appreciated that the location of the controls 220 is flexible, and may be adjusted based on the specific packaging requirements dictated by the surroundings. The controls 220 may include, for example, ON/OFF control, variable speed control, and maximum speed of the blender 60. The controls 220 may be any type of sensor or sensors that detect a change of state that a user inputs such as, but not limited to, push buttons, tactile membrane buttons, haptic buttons, or piezo electric sensors. In an alternative approach, the controls 220 may a single input or button. When the input is selected by a user, the blender 60 may first operate at a low speed, and then ramps up to maximum speed in a predetermined about of time. The user may turn off the blender using the same input. This operating sequence may also be accomplished with two inputs as well, a first input for turning the blender ON and one for turning the blender 60 OFF. The ramping up of the blender speed may be determined by a control module located within the blender, such as a control module 252 (shown in FIG. 14), which is described in greater detail below. In another approach, a single input or button may be included, and a user may press the button to ramp up the speed in a controlled manner of the blender 60 until a specific speed is reached. The button may then be released to maintain the specific speed. A second press of the button would then turn the blender 60 OFF.

The controls 220 may be in communication with a control module 230 (shown in phantom line in FIG. 10). In the embodiment as shown in FIG. 10, the control module 230 may be located below the counter top 62, and is hidden from view. Specifically, the control module 230 may be attached along an interior wall 232 of a cabinet 234 that the counter top 62 is seated upon. The control module 230 may be located in a corner 236 of the cabinet 234, and in a location as far away from the electric motor 20 as possible within the cabinet 234. Thus, if fluid exits the housing 22, the control module 230 may be positioned in a location to avoid fluid spray. However, it is to be appreciated that FIG. 10 is merely exemplary in nature, and the control module 230 may be mounted in a variety of different locations as well. For example, the control module 230 may be mounted upon a wall of the kitchen. In another example, if the blender 60 and the electric motor 20 are located upon a yacht, then the control module 230 may be mounted along a galley wall, or within a cabinet located within the galley.

The control module 230 may be used to control operation of the electric motor 20. The control module 230 may refer to, or be part of, an application specific integrated circuit (ASIC), an electronic circuit, a combinational logic circuit, a field programmable gate array (FPGA), a processor (shared, dedicated, or group) comprising hardware or software that executes code, or a combination of some or all of the above, such as in a system-on-chip. The control module 230 may in communication with the controls 220 through either a wired connection, or a wireless connection. The wireless connection may be based on any type of wireless communication protocol. The wireless communication protocol may be based on radio frequency (RF) communication. Some examples of wireless communication that may be used include, but are not limited to, near field communication (NFC), Bluetooth® or Wi-Fi®, or infrared. Similarly, if the controls 220 are part of a control panel (not illustrated) mounted on a surface remote from the electric motor 20, the control panel may be in communication with the control module 230 based on a wired connection, or by a wireless connection as well.

FIG. 14 is an exemplary schematic diagram of the lid 204 illustrated in FIG. 10, the control module 230, and the electric motor 20. In the embodiment as shown in FIG. 14, wireless communication is used to communicate signals from the controls 220 to the control module 230 through an antenna 250 of the electric motor 20, however it is appreciated that a wired connection may be used as well. It should be appreciated that a control structure (not illustrated) for the controls 220 may also be provided. The control structure allows for low voltage at operator interface (i.e., the interface along the lid 204). Furthermore, in the embodiment as shown, the lid 204 includes electronic components such as the control module 252 in communication with the controls 220 and an antenna 254, however the electronic components may also be located within the jar 202 of the blender 60 as well. The electronic components may also be located within another component as well, such as a wall.

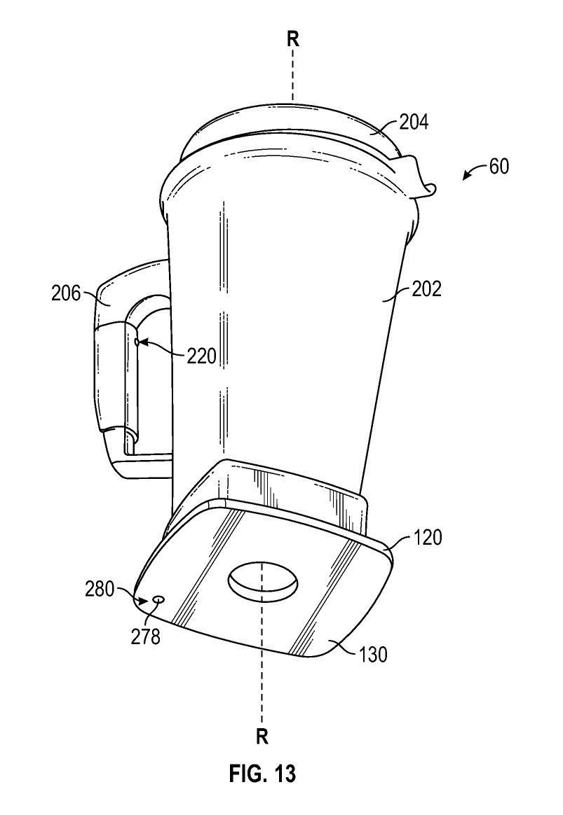

The control module 252 is in communication to receive a signal 258 from the controls 220. The signal 258 may be indicative of operation of the blender 60 (i.e., the signal 258 is indicative of an operator manipulating one or more of the controls 220). For example, the signal 258 may indicate that the blender 60 should be turned ON/OFF, the electric motor 20 should operate at a specific speed, or at maximum power. Although FIG. 14 illustrates the signal 258 being generated by the controls 220, it is to be appreciated that the signal 258 may also be generated by another device as well, such as a positional sensor 278 shown in FIG. 13.

The antenna 254 is in communication with the control module 230, and sends wireless communication indicative of the signal 258 to the antenna 250 of the control module 230. The antenna 250 may be connected to a transceiver 252. The control module 230 is in communication with a power source 272. The power source 272 provides energy to the electric motor 20. The control module 230 may output a pre-set amount of power based on the signal 258 generated by the controls 220. The pre-set amount of power directly controls the rotational speed of the electric motor 20 (i.e., the rotational speed of the shaft 30 seen in FIG. 2).

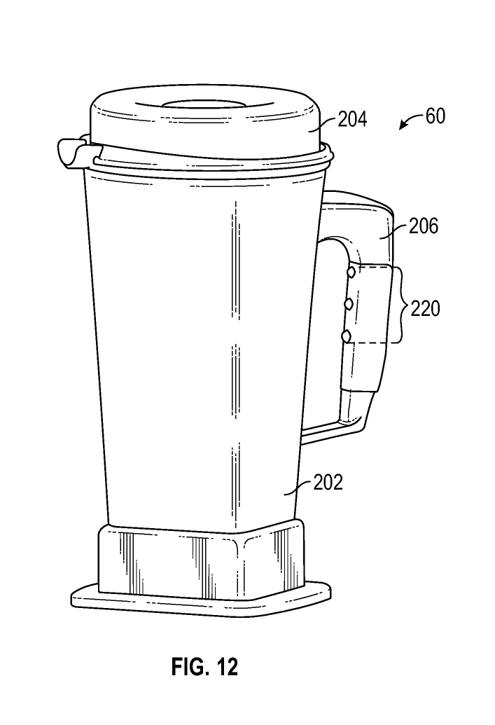

FIG. 11 is an illustration of the blender 60 where a portion of the controls 220 are located on the lid 204 and a portion of the controls 220 are located on the handle 206. For example, the handle 206 could include a single ON/OFF control 220 and the lid 204 could include variable and maximum power controls 220. Alternatively, the lid 204 may include a single ON/OFF control 220 and the handle 206 may include variable and maximum power controls 220. It is to be appreciated that the controls 220 may be mixed between the lid 204 and the handle 206 in any number of configurations. FIG. 12 is an embodiment of the blender 60 where all of the controls 220 are located on the handle 206 of the jar 202.

FIG. 13 is an embodiment of the blender 60 where an ON/OFF control 220 is located on the handle 206. The speed of the electric motor 20 may be determined based on angular displacement of the blender 60 about the axis of rotation R-R. Specifically, a user may rotate the blender 60 as well as the pad 120 about the axis of rotation R-R upon the counter top 62 (seen in FIG. 10). In one embodiment, the positional sensor 278 that is part of a positional sensing system 280 may be disposed along the lower surface 130 of the pad 120. The positional sensing system 280 may include the positional sensor 278 and the control module 230 (shown in FIG. 10).

The positional sensor 278 may generate a signal indicative of the angular displacement of the lower surface 130 of the pad 120 relative to the upper surface 64 of the counter top 62 (FIG. 10). The positional sensing system 280 may adjust the speed of the working piece (i.e., the blade) of the blender 60 based on the angular displacement of the blender 60 about the axis R-R of rotation as indicated by the positional sensor 278. More specifically, the control module 230 of the positional sensing system 280 includes control logic for determining the pre-set amount of power required by the electric motor 20 based on the angular displacement as indicated by the positional sensor 278.

The positional sensor 278 may be any type of sensor or system for detecting a change in the rotational movement such as, for example, an optical sensor, an optical encoder, or a set of magnets (one of the magnets may be placed underneath the counter top 62). Instead of the positional sensor 278 located along the lower surface 130 of the pad 120, the positional sensing system 280 may include other types of position detection systems instead such as an encoder (not illustrated) that is actuated through the fitting 63, or a lever (not illustrated) that may be driven to varying angles based on the rotation of the blender 60. The displacement of the lever in relation to the rotation of the blender 60 may be measured by a variety of position sensing devices such as, for example, linear potentiometer or a linear variable differential transformer (LVDT). Furthermore, an electronic compass module may also be used to sense relative angular displacement of the blender 60 either directly, or indirectly through a mechanical linkage.

FIGS. 15-17 illustrate an alternative embodiment of a drive mechanism 310. Similar to the drive mechanism 10 as described above and shown in FIGS. 1-9, the drive mechanism 310 may also be used to transmit rotational motion from the shaft 30 of the electric motor 20 to an appliance (shown in FIGS. 10-13). However, unlike the drive mechanism 10 as shown above, the drive mechanism 310 may be permanently coupled to the upper portion 50 of the shaft 30, and is generally removeable. Instead, a driver 308 is removably coupled to the drive mechanism 310. Furthermore, unlike the embodiment as shown in FIG. 2, the drive mechanism 310 may be seated entirely within the fitting 63.

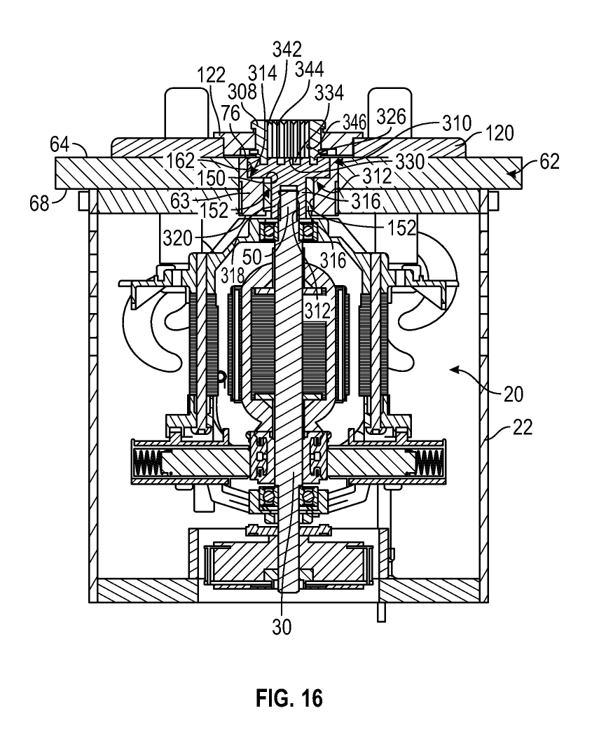

In the embodiment as illustrated in FIGS. 15-16, the drive mechanism 310 is a single, unitary piece, however it is to be understood that this illustration is not limiting in nature. The drive mechanism 310 may include a stepped outer profile 312 that corresponds with the stepped recess 150 defined by the fitting 63. Specifically, the drive mechanism may define a shoulder 314 that corresponds to the step 152 defined along the inner wall 154 of the fitting 63. A bearing 316 may be placed between a stem portion 318 of the drive mechanism 310 and a lower surface 320 of the fitting 63. The bearing 316 may be a sleeve bearing constructed of a high speed plastic such as, for example, Nylatron-GS®. Alternatively, the bearing 316 may also be a sintered bronze bearing that is oil impregnated. As seen in FIG. 16, the lower surface 320 of the fitting 63 is located along the inner wall 154 and below the step 152 of the fitting 63.

The stem portion 318 of the drive mechanism 310 may define a centrally located cavity 322 located along the axis of rotation R-R of the electric motor 20. The cavity 322 may be shaped to receive the upper portion 50 of the shaft 30. Specifically, in one embodiment, the centrally located cavity 322 of the drive mechanism 310 may be permanently engaged with the shaft 30 of the electric motor 20 by a relatively light press or interference fit.

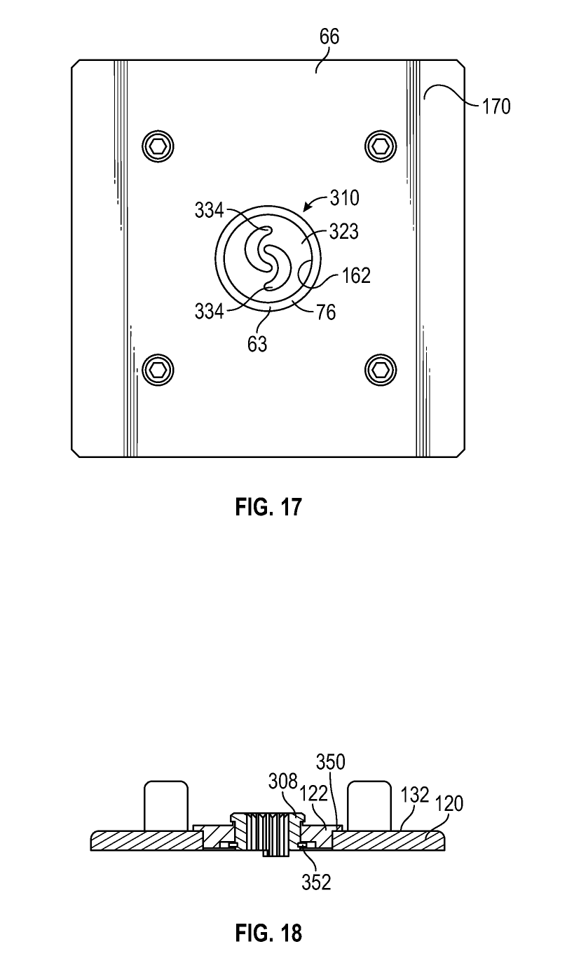

FIG. 17 is a top view of the drive mechanism 310 and the upper surface 170 of the motor mount 66, where the counter top 62, the pad 120, the adapter 122, and the driver 308 have been removed for clarity. Referring to both FIG. 16-17, an uppermost surface 323 of the drive mechanism 310 may define one or more recesses 334 that are each shaped to receive and removably couple a corresponding male portion 326 located along a lower surface 330 of the driver 308. For example, in the embodiment as shown in FIG. 17, the recesses 334 are a pair of crescents that interlock with one another and represent a company logo, however it is to be appreciated that the drive mechanism is not limited to only crescent shaped recesses 334.

As seen in FIGS. 16 and 17, in one embodiment the uppermost surface 323 of the drive mechanism 310 may be substantially level or flush with the upper surface 64 of the counter top 62 as well as the upper surface 76 of the fitting 63. Thus, the drive mechanism 310 is visible to a user (when the driver 308 is removed). However, similar to the embodiment as shown in FIGS. 1-9, the electric motor 20, the housing 22, and the shaft 30 are all hidden from view by the counter top 62. Furthermore, as seen in FIG. 17, the uppermost surface 323 of the drive mechanism 310 seals off the opening 162 defined by the upper surface 76 of the fitting 63, thereby substantially preventing ingression of fluid into the stepped recess of the fitting 63. Referring to both FIGS. 16 and 17, the drive mechanism 310 creates a smooth, continuous surface along the upper surface 64 of the counter top 62.

Referring to FIGS. 16 and 17, the driver 308 may define a female portion or drive socket 342. A plurality of splines 344 may be arranged around an inner surface 346 of the drive socket 342 of the driver 308. The drive socket 342 of the driver 308 is shaped to receive the male piece (not illustrated) of an appliance, such as the blender 60 described above. The drive socket 342 of the driver 308 transfers the rotational motion of the shaft 30 to the male piece of the appliance. Moreover, if a user wishes to operate a mixer instead of the blender 60, the user may remove and replace the driver 308 with another driver having a drive socket shaped to receive the male portion of the mixer. Thus, it should be appreciated that the driver 308 may be adaptable to accommodate any number and variety of appliances.

FIG. 18 is an enlarged view of the driver 308, the pad 120, and the adapter 122. It should be appreciated that in the embodiment as shown in FIG. 18, the adapter 122 may include a shelf 350 that abuts against the upper surface 132 of the pad 120. Moreover, as seen in FIG. 18, a snap ring or retaining ring 352 may surround an outer surface 354 of the driver 308. The retaining ring 352 may be used to retain the driver 308 into the adapter 122.

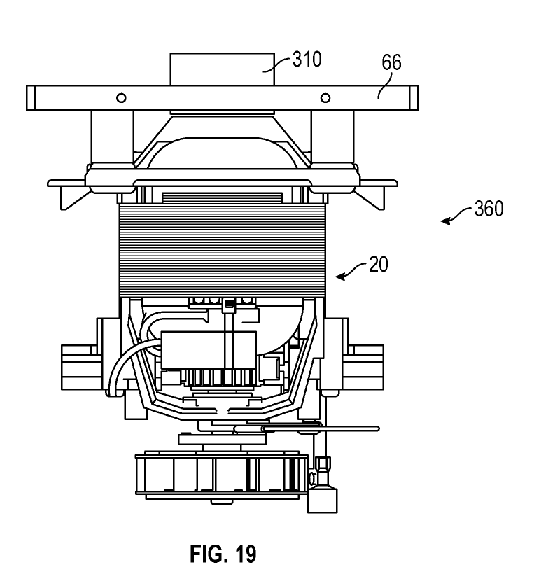

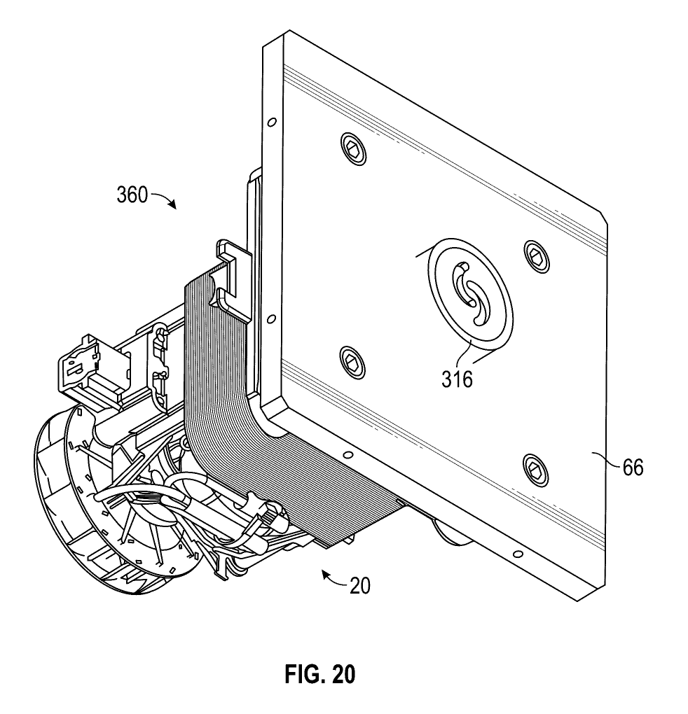

FIGS. 19-20 are views of the electric motor 20, the motor mount 66, and the drive mechanism 310. It should be appreciated that the counter top 62, the driver 308, the housing 22 are omitted from these views for simplicity. As can be seen in FIGS. 19-21, the electric motor 20, the motor mount 66, and the drive mechanism 310 define a modular assembly 360. The modular assembly 360 defines an assembly that may be easily and quickly installed and removed by a user. Thus, the modular assembly 360 may be installed in any location along the bottom surface 68 of the counter top 62 (FIG. 16), thereby providing flexibility in mounting locations. Accordingly, the drive mechanism 310 and the electric motor 20 may be installed in a variety of locations, and may even be installed in a location where space is relatively limited and includes various packaging constraints. Therefore, the modular assembly 360 may be used in applications where space is limited and presents packaging challenges, such as kitchen in a recreational vehicle, a yacht, or an airplane.

Referring generally to the figures, the drive mechanism and electric motor provide numerous advantages and benefits, which are described above. Furthermore, it should also be appreciated that the disclosed drive mechanism and electric motor may also provide a user with a space-saving, flexible approach for accommodating numerous appliances in an application where space is limited. For example, it may be especially desirable for a kitchen countertop of a vehicle, such as a recreational vehicle, a yacht, or an airplane to incorporate space-saving features, since the kitchen countertop is typically limited in size. The disclosed electric motor may be located underneath a kitchen counter top, which saves a considerable amount of space. Furthermore, a user may simply place any number of appliances such as, for example, a blender jar over the drive mechanism in order to drive the appliance.

While the forms of apparatus and methods herein described constitute preferred aspects of this disclosure, it is to be understood that the disclosure is not limited to these precise forms of apparatus and methods, and the changes may be made therein without departing from the scope of the disclosure.

What is claimed is:

1. An assembly for transmitting power to an appliance, wherein the appliance is placed upon a counter top that defines an aperture, the assembly comprising:
an electric motor;
a rotatable shaft driven by the electric motor, wherein the electric motor and the rotatable shaft are located below a first side of the counter top and are hidden from view; and
a drive mechanism removably coupled to the rotatable shaft, the drive mechanism including a first portion removably coupled to the rotatable shaft and a second portion that defines a drive socket shaped to receive a male portion of the appliance, and wherein at least a portion of the drive mechanism extends through the aperture in the counter top and is located above a second side of the counter top.

2. The assembly of claim 1, wherein the first portion of the drive mechanism is a shaft that defines a cavity that is shaped to receive an upper portion of the rotatable shaft.

3. The assembly of claim 1, wherein the second portion of the drive assembly is a coupling, and wherein the drive socket includes an inner surface and a plurality of splines arranged around the inner surface.

4. The assembly of claim 1, wherein the drive mechanism is removably coupled to an upper portion of the rotatable shaft.

5. The assembly of claim 1, comprising a housing that contains the electric motor, wherein the housing defines at least one cooling aperture.

6. The assembly of claim 5, wherein the housing includes a bottom plate, and wherein a fitting is located along the bottom plate.

7. The assembly of claim 6, wherein the fitting is connected to a drain hose.

8. The assembly of claim 5, wherein the housing includes a bottom plate, and wherein the bottom plate defines an aperture and a shelf surrounding the aperture defined by the bottom plate.

9. The assembly of claim 5, comprising a motor mount, wherein the drive mechanism, the electric motor, the housing, and the motor mount define a modular assembly.

10. The assembly of claim 1, comprising a fitting that is received by the aperture in the counter top, wherein the fitting surrounds an upper portion of the rotatable shaft and a portion of the drive mechanism.

11. The assembly of claim 10, wherein the fitting defines an upper surface, and wherein the upper surface of the fitting is flush with an upper surface of the counter top.

12. The assembly of claim 11, comprising a cap shaped to fit within a recess defined by the fitting, wherein the cap is received by the recess defined by the fitting if the drive mechanism is removed from the rotatable shaft.

13. The assembly of claim 12, wherein the cap defines an uppermost surface, and wherein the uppermost surface of the cap is flush with the upper surface of the fitting is flush and the upper surface of the counter top.

14. The assembly of claim 10, comprising a motor mount that defines an aperture, wherein the fitting is threadingly engaged with the aperture defined by the motor mount and creates a fluid-tight seal between the electric motor and the motor mount.

15. The assembly of claim 1, comprising a pad that is placed along an upper surface of the counter top, wherein the pad provides a level surface to place the appliance upon.

16. An assembly for transmitting power to an appliance, wherein the appliance is placed upon a counter top that defines an aperture and an upper surface, the assembly comprising:
an electric motor;
a rotatable shaft driven by the electric motor, wherein the electric motor and the rotatable shaft are located below a first side of the counter top and are hidden from view; and
a drive mechanism permanently coupled to the rotatable shaft, the drive mechanism defining an uppermost surface, a first portion permanently coupled to the rotating shaft, and a second portion that defines at least one retaining feature shaped to removably couple a driver for the appliance, wherein the uppermost surface of the drive mechanism is substantially flush with the upper surface of the counter top and is visible through the aperture of the counter top.

17. The assembly of claim 16, wherein the drive mechanism is permanently coupled to an upper portion of the rotatable shaft by a press fit engagement.

18. The assembly of claim 16, comprising a motor mount for the electric motor, wherein the electric motor, the motor mount, and the drive mechanism define a modular assembly.

19. The assembly of claim 16, comprising a housing that contains the electric motor, wherein the housing defines at least one cooling aperture.

20. The assembly of claim 16, comprising a fitting that is received by the aperture in the counter top, wherein the fitting surrounds an upper portion of the rotatable shaft and a portion of the drive mechanism.

21. The assembly of claim 20, wherein the fitting defines an upper surface, and wherein the upper surface of the fitting is flush with the upper surface of the counter top.

22. The assembly of claim 9, comprising a motor mount that defines an aperture, wherein the fitting is threadingly engaged with the aperture defined by the motor mount and creates a fluid-tight seal between the electric motor and the motor mount.

23. The assembly of claim 16, comprising a pad that is placed along an upper surface of the counter top, wherein the pad provides a level surface to place the appliance upon.

24. An assembly for transmitting power to an appliance, wherein the appliance is placed upon a counter top that defines an aperture and an upper surface, comprising:
an electric motor;
a rotatable shaft driven by the electric motor to create rotational motion, wherein the electric motor and the rotatable shaft are located below a first side of the counter top and are hidden from view;
a male piece that is part of the appliance and transfers the rotational motion of the rotatable shaft to a working piece of the appliance; and
a drive mechanism removably coupled to the rotatable shaft, the drive mechanism including a first portion removably coupled to the rotatable shaft and a second portion that defines a drive socket shaped to receive the male piece of the appliance, and wherein at least a portion of the drive mechanism extends through the aperture in the counter top and is located above a second side of the counter top.

25. The assembly of claim 24, wherein the appliance is one of a food processor, a vacuum cleaner, an air compressor, an ice cream maker, a meat grinder, a bread maker, a mixer, a drink maker, and a coffee grinder.

26. The assembly of claim 24, wherein the appliance is a blender having a jar and a lid.

27. The assembly of claim 26, wherein the blender includes controls for operating the electric motor, and wherein the controls are located on at least one of the jar and the lid of the blender.

28. The assembly of claim 27, comprising a control module for operating the electric motor, wherein the controls are in wireless communication with the control module.

29. The assembly of claim 27, comprising a control module for operating the electric motor, wherein the controls are wired to the control module.

30. The assembly of claim 24, comprising a pad that is placed along an upper surface of the counter top, wherein the pad provides a level surface to place the appliance upon.

31. The assembly of claim 30, comprising a positional sensor disposed along a lower surface of the pad, wherein the positional sensor generates a signal indicative of angular displacement of the lower surface of the pad relative to the upper surface of the counter top.

32. The assembly of claim 31, comprising a control module that is part of a positional sensing system, wherein the control module includes control logic for determining a pre-set amount of power required by the electric motor based on the angular displacement as indicated by the positional sensor.

33. The assembly of claim 24, comprising a control module for operating the electric motor and controls for operating the electric motor, wherein the controls are mounted on a surface located remotely from the electric motor.

34. The assembly of claim 33, wherein the controls are in wireless communication with the control module.

35. The assembly of claim 33, wherein the controls are wired to the control module.

36. The assembly of claim 33, wherein the controls are located upon the upper surface of the counter top.
